(19) United States
(12) Patent Application Publication
(10) Pub. No.: US 2023/0092751 A1
(43) Pub. Date: Mar. 23, 2023

(54) PREDICTION-BASED METHOD FOR ANALYZING CHANGE IMPACT ON SOFTWARE COMPONENTS

(71) Applicant: ProphetStor Data Services, Inc., Taichung (TW)

(72) Inventors: Wen-Shyen Chen, Taichung (TW); Ming-Jye Sheu, Saratoga (US); Henry H. Tzeng, San Jose, CA (US)

(21) Appl. No.: 17/479,065

(22) Filed: Sep. 20, 2021

(51) Int. Cl. G06F 8/77; G06N 5/04

(52) U.S. Cl. CPC G06F 8/77; G06N 5/046

(57) ABSTRACT

A prediction-based method for analyzing change impact on software components is disclosed. The method comprises the steps of: providing a software system comprising a main software component and at least one auxiliary software component; collecting metrics associated with the workload and each auxiliary software component separately and sequentially before a change of the software system is introduced; calculating correlation coefficients between the collected metrics associated with the workload and each auxiliary software component; if an absolute value of the correlation coefficient is smaller than a threshold value, building a prediction model from the collected metrics associated with the corresponding auxiliary software component; recording metrics associated with the corresponding auxiliary software component sequentially; inputting the collected metrics associated with the corresponding auxiliary software component to the prediction model to obtain predicted metrics of the corresponding auxiliary software component; and calculating a performance difference value by using the recorded metrics.

### FIELD OF THE INVENTION

The present invention relates to a method for analyzing change impact on software components. More particularly, the present invention relates to a prediction-based method for analyzing change impact on software components.

### BACKGROUND OF THE INVENTION

When a software system including a number of software components is deployed over a computing equipment, such as server cluster, to meet requirements of a workload, changes of the software system are commonly used to improve the performance of the software system. Typical scenarios of the changes are upgrades of software or adjustments of component configuration parameters. Even a change is applied to one of the software components, some change impacts might inevitably happen and cause a ripple effect of performance and/or resource usage to other software components in the same application. For DevOps team of the software system, a key concern is to understand the change impact when the change is introduced to the software system.

While metrics in a software application system, such as memory utilization, CPU utilization, I/O throughput, response time, request per second, latency etc., could be monitored, the real “change impact” is difficult to measure as there is no guarantee that the workload, before and after the change, is about the same for the comparison, due to the dynamic and variant nature of the workload.

A traditional approach to analyze the change impacts on software components is illustrated in FIG. 1. A cloud service with software applications consisting of four individual software components is deployed for a main workload. There are data requests and/or responses between software components, which are the source of the impact for related software component. The cloud service may be an ERP. The main workload from an external system, e. g. the computer hosts in a factory, is taken by a first software component. The first software component deals with the all the operating requests and responses to the external system. Each of the rest software components support a specific job function and has internal data requests and responses with other software component(s). A metric collector installed in a server keeps monitoring metrics from all the software components. In this scenario, the metrics of the main workload is the metrics of the first software component. If the administrator of the ERP wants to know what are impacted in all software components when the second software component is upgraded, the traditional approach may compare real operating metrics with the collected metrics, and use the comparison results to check the change impacts, which may be used to adjust the configuration parameters of the software components or a reference for further upgrades. This is usually implemented by a benchmark program. The limitation of such approach is that, in order to have meaningful comparisons, one needs to find operation periods before and after the change with almost the same workload metrics. Otherwise, the comparison results cannot be trusted as different workload patterns usually result in different operating metrics from the software components in the system. This is not an easy task in a production environment as the workload changes dynamically. Therefore, this type of benchmark program does not necessary give you an accurate description of the impacts introduced by a change to the system.

In order to provide a precise way to evaluate the change impact to save operating costs, an innovative method is disclosed.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

According to an aspect of the present invention, a prediction-based method for analyzing change impact on software components comprises the steps of: a) providing a software system comprising a main software component for fulfilling requests from a workload and at least one auxiliary software component dealing with a specific job for the main software component, deployed over a computing hardware environment; b) collecting metrics associated with the workload and each auxiliary software component separately and sequentially before a change of the software system is introduced; c) calculating correlation coefficients between the collected metrics associated with the workload and that associated with each auxiliary software component; d) if an absolute value of the correlation coefficient is greater than a threshold value, building a prediction model from the collected metrics associated with the workload and the collected metrics associated with the corresponding auxiliary software component for predicting the metrics of the corresponding auxiliary software component in a period of time in the future; e) recording metrics associated with the corresponding auxiliary software component and the workload sequentially during an evaluating time beginning when the change of the software system was introduced; f) inputting the collected metrics associated with the workload and the corresponding auxiliary software component collected in step b) to the prediction model to obtain predicted metrics of the corresponding auxiliary software component; and g) calculating a performance difference value by using the recorded metrics associated with the corresponding auxiliary software component and the predicted metrics of the corresponding auxiliary software component.

According to another aspect of the present invention, a prediction-based method for analyzing change impact on software components comprises the steps of: a) providing a software system comprising a main software component for fulfilling requests from a workload and at least one auxiliary software component dealing with a specific job for the main software component, deployed over a computing hardware environment; b) collecting metrics associated with the workload and each auxiliary software component separately and sequentially before a change of the software system is introduced; c) calculating correlation coefficients between the collected metrics associated with the workload and that associated with each auxiliary software component; d) if an absolute value of the correlation coefficient is smaller than a threshold value, building a prediction model from the collected metrics associated with the corresponding auxiliary software component for predicting the metrics of the corresponding auxiliary software component in a period of time in the future; e) recording metrics associated with the corresponding auxiliary software component sequentially during an evaluating time beginning when the change of the software system was introduced; f) inputting the collected metrics associated with the corresponding auxiliary software component collected in step S02 to the prediction model to obtain predicted metrics of the corresponding auxiliary software component; and g) calculating a performance difference value by using the recorded metrics associated with the corresponding auxiliary software component and the predicted metrics of the corresponding auxiliary software component.

Preferably, the change of the software system may be an upgrade of the software system, an adjustment of application configuration parameters of the software system, installing a new auxiliary software component, or deleting a current auxiliary software component.

Preferably, the computing hardware environment may be a workstation host or a server cluster.

Preferably, the metric may be amount of used memory, amount of used CPU, I/O throughput, response time, request per second, or latency.

Preferably, the performance difference value may be mean percentage error.

Preferably, the collected metrics for building the prediction model may be of two categories.

Preferably, the prediction model may be built by a timeseries forecasting algorithm.

Preferably, timeseries forecasting algorithm may be ARIMA (Auto Regressive Integrated Moving Average) or SARIMA (Seasonal Auto Regressive Integrated Moving Average).

According to the present invention, the correlation between the metrics of the workload and that of each software component is taken into consideration. The prediction model can be built for predicting certain kind of metric for one software component in the future. Comparing the predicted metrics with real collected metrics, the change impact of said software component can be evaluated. The results can be used for further changes as well as saving operating costs.

### BRIEF DESCRIPTION OF THE DRAWINGS

FIG. 1 illustrates a deployment framework of a software system for a traditional approach to analyze change impacts on software components.

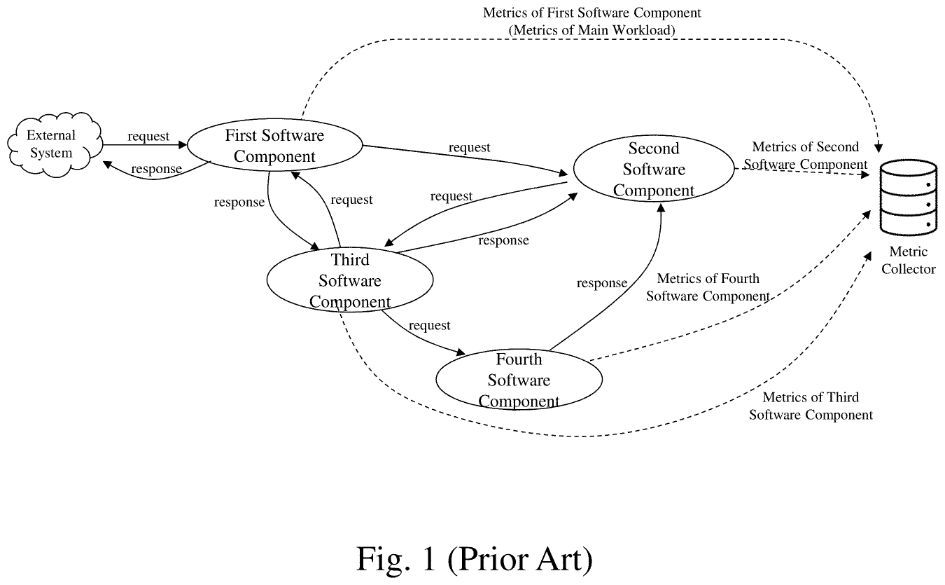

FIG. 2 is a flow chart of a prediction-based method for analyzing change impact on software components according to the present invention.

FIG. 3 is another flow chart of a prediction-based method for analyzing change impact on software components according to the present invention.

FIG. 4 illustrates a deployment framework of a software system for the prediction-based method according to the present invention to analyze change impacts on software components.

FIG. 5 tabulates calculation data and results of correlation coefficients and performance difference values.

FIG. 6 is a graph showing metrics associated with the workload, collected/recorded metrics associated with a first auxiliary software component, and predicted metrics of the first auxiliary software component changing with time.

FIG. 7 is a graph showing metrics associated with the workload, collected/recorded metrics associated with a second auxiliary software component, and predicted metrics of the second auxiliary software component changing with time.

FIG. 8 is a graph showing metrics associated with the workload, collected/recorded metrics associated with a third auxiliary software component, and predicted metrics of the third auxiliary software component changing with time.

### DETAILED DESCRIPTION OF THE PREFERRED EMBODIMENTS

The present invention will now be described more specifically with reference to the following embodiments.

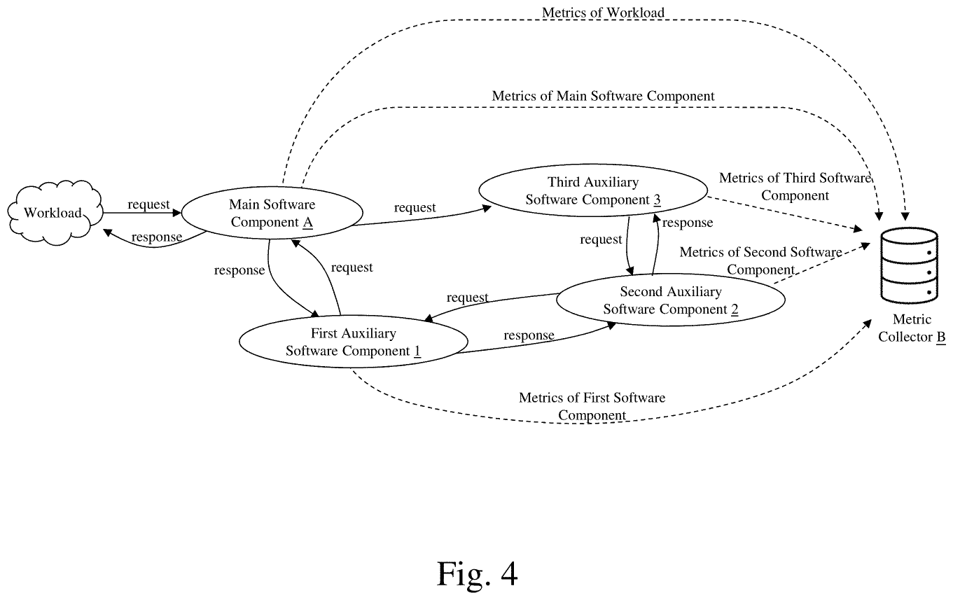

Please refer to FIG. 4 first. It illustrates a deployment framework of a software system for the prediction-based method according to the present invention to analyze change impacts on software components. FIG. 4 shows three kinds of operational relationships of software components. A software system which includes a main software component A, a first auxiliary software component 1, a second auxiliary software component 2, and a third auxiliary software component 3 is deployed over a computing hardware environment. The computing hardware environment refers to a powerful computing hardware, capable of dealing with complex computing requests from a workload. The computing hardware environment may be, but not limited to a workstation host and a server cluster. In the computing hardware environment, there are many central processing units (CPU), huge amount of dynamic random access memory (DRAM) modules (or simply called memory), and limited resources of I/O throughput. CPU and DRAM are resources for a workload to use through the main software component A. They can be subdivided into actual usages for the first auxiliary software component 1, the second auxiliary software component 2, and the third auxiliary software component 3. The I/O throughput is a comprehensive efficiency value of the computing hardware environment for inputting and outputting data. A large of the I/O throughput may be occupied by the workload, and the same amount of I/O throughput is shared by the three auxiliary software components. Similarly, response time, request per second, and latency are indicators which respond to the workload. They all have contributions from each auxiliary software component. In the present invention, the metric refers to the amount of used memory, the amount of used CPU, I/O throughput, response time, request per second, or latency and used to analyze impacts caused by “change” on all software components. In the embodiment of the present invention, latency (second) associated with the workload and the amount of used CPU occupied by the auxiliary software components are used for illustration. The change of the software system may have different types. For example, it may be an upgrade of the software system, an adjustment of application configuration parameters of the software system, installing a new auxiliary software component, deleting a current auxiliary software component, etc.

In FIG. 4, the main software component A is the element interacting with the workload in an external system. Metrics of the main software component A is equivalent to the metrics of the workload. The main software component A receives requests from the workload, executes the corresponding program operation, and sends back responses to specific sources for the workload. For example, the workload may be Email requests from a company, and the main software component A is an Email module run in the company's servers. According to the present invention, the software system has a technological architecture: in addition to including the main software component A for fulfilling requests from the workload, the software system also has at least one auxiliary software component dealing with a specific job for the main software component A. In FIG. 4, the first auxiliary software component 1 “works” for the main software component A directly. The first auxiliary software component 1 executes data retrieval for all emails. The second auxiliary software component 2 “works” for the first auxiliary software component 1 to manage an email content database for all emails. Namely, the second auxiliary software component 2 “works” indirectly for the main software component A. The third auxiliary software component 3 “work” for the second auxiliary software component 2 and under the commends from the main software component A to execute data access to an external data center. The requests from the main software component A will be fulfilled by the first auxiliary software component 1. There are data (requests and responses) delivered between the main software component A and the first auxiliary software component 1, between the first auxiliary software component 1 and the second auxiliary software component 2, and the second auxiliary software component 2 and the third auxiliary software component 3.

A metric collector B is also installed in the computing hardware environment. It may be an independent data monitoring software to collect metrics associated with the software components from each of them. It should be emphasized that the metric collector B can collect metrics associated with the workload since they are identical to the metrics of the main software component A.

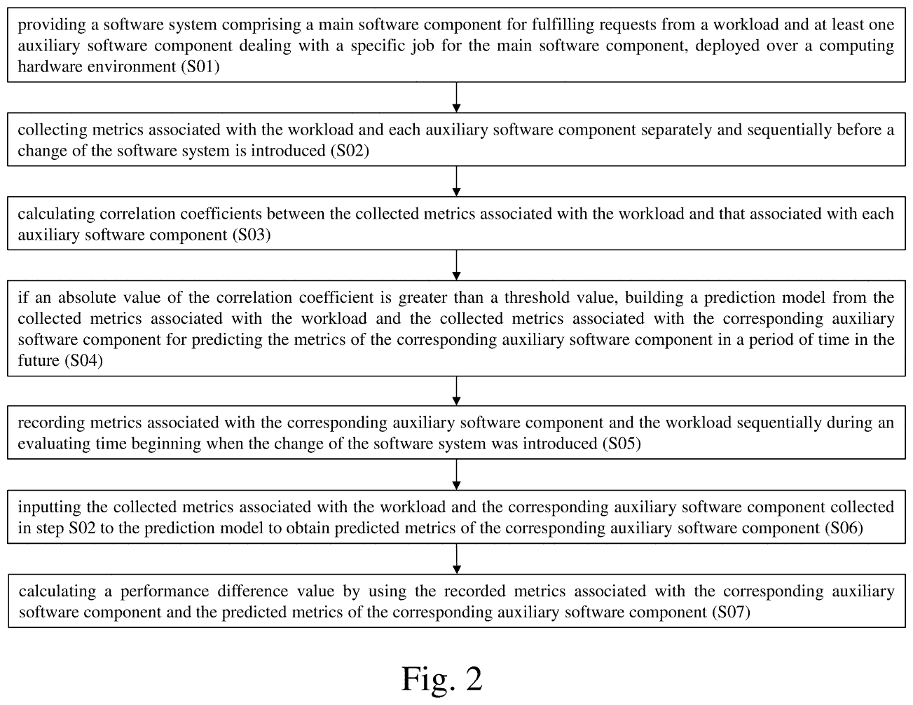

Please refer to FIG. 2. It is a flow chart of a prediction-based method for analyzing change impact on software components according to the present invention. A first step of the prediction-based method is providing a software system comprising a main software component for fulfilling requests from a workload and at least one auxiliary software component dealing with a specific job for the main software component, deployed over a computing hardware environment (S01). This step is just to define an applicable architecture as described above.

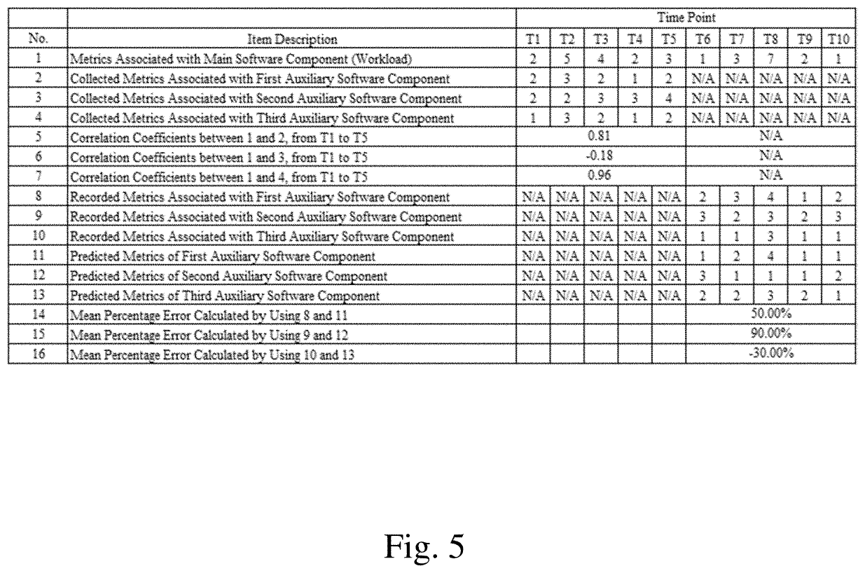

A second step of the prediction-based method is collecting metrics associated with the workload and each software component separately and sequentially before a change of the software system is introduced (S02). As mentioned above, latency associated with the workload and the amount of used CPU occupied by the auxiliary software components are used for illustration. This is to use the performance relationship between two different metrics to predict the future performance of one of them. In other embodiments, performance of only one metric is enough to predict itself in the future. An example is shown in FIG. 5. FIG. 5 also tabulates calculation data and results of correlation coefficients and performance difference values. The metric collector B sequentially collects metrics (latencies) associated with the workload (the main software component A) from T1 to T5. The data are 2, 5, 4, 2, and 3. Time interval between adjacent time points is the same. For example, 5 seconds. It is not limited by the present invention as long as the chosen time interval can utilize less hardware resource or have better performance on change impact analysis. The change, e.g., upgrading the first auxiliary software component 1, happens at T6. The metric collector B also separately and sequentially collects metrics (the amount of used CPU) associated with the first auxiliary software component 1, the second auxiliary software component 2, and the third auxiliary software component 3 from T1 to T5. Corresponding data are shown on the time point field of item description No. 2 to No. 4.

A third step of the prediction-based method is calculating correlation coefficients between the collected metrics associated with the workload and that by each auxiliary software component (S03). Correlation coefficient is a numerical measure of some type of correlation between two groups of variables. According to its calculation formula, Correlation coefficient varies between −1 and 1. Taking the data on item description No. 1 and No. 2 from T1 to T5 for calculation, the correlation coefficient is 0.81. Similarly, taking the data on item description No. 1 and No. 3 from T1 to T5 for calculation, the correlation coefficient is −0.18. Taking the data on item description No. 1 and No. 4 from T1 to T5 for calculation, the correlation coefficient is 0.96.

Based on the result of the step S03, the prediction-based method has different following steps. If an absolute value of the correlation coefficient is greater than a threshold value, a fourth step is building a prediction model from the collected metrics associated with the workload and the collected metrics associated with the corresponding auxiliary software component for predicting the metrics of the corresponding auxiliary software component in a period of time in the future (S04). Here, the threshold value restricts the relationship of the trends in the use of hardware resources or performance between the workload and each auxiliary software component. In this example, the threshold value is set as 0.7. It means the trends should be very close in the same direction or in the reverse direction, indicating there is a strong correlation between the collected metrics associated with the workload and the collected metrics associated with the corresponding auxiliary software component. In other embodiments, the threshold value can be any number between 0 and 1. It is not limited by the present invention. From FIG. 5, the correlation coefficient between the collected metrics associated with the workload and the collected metrics associated with the first auxiliary software component 1, and the correlation coefficient between the collected metrics associated with the workload and the collected metrics associated with the third auxiliary software component 3 meet the requirements. According to the spirit of the present invention, the way that builds the prediction model is not restricted. Any exiting data estimating model can be used, even it is a simple statistical formula. A more precise predictive model is preferred since it may save resource usage or provide better results. If required, machine-learning predictive models can be used. Preferably, the prediction model is built by a timeseries forecasting algorithm. The timeseries forecasting algorithm may be ARIMA or SARIMA. In this embodiment, the prediction model is built by ARIMA. The prerequisite for building the prediction model is inputs must be the collected metrics associated with the workload and the collected metrics associated with the corresponding auxiliary software component before T6. Obviously, the collected metrics for building the prediction model are of two categories.

Then, based on the result of the step S04, a fifth step of the prediction-based method is recording metrics associated with the corresponding auxiliary software component and the workload sequentially during an evaluating time beginning when the change of the software system was introduced (S05). As described above, two auxiliary software components, the first auxiliary software component 1 and the third auxiliary software component 3, are so-called corresponding auxiliary software components in step S05. Therefore, the metrics associated thereto are recorded by the metric collector B. The verb “record” used here represent the same thing as the verb “collect” used in the step S02. They all describe that the metric collector B gets data from the software components. Different verbs are used to describe metrics separately in different steps. In this embodiment, the evaluating time starts from T6 and end at T10. The recorded metrics associated with the workload from T6 to T10 are 1, 3, 7, 2, and 1. There are 5 metric data associated with the first auxiliary software component 1 or the third auxiliary software component 3 recorded by the metric collector B. They are 2, 3, 4, 1, and 2 for the first auxiliary software component 1, and 1, 1, 3, 1, and 1 for the third auxiliary software component 3.

A sixth step of the prediction-based method is inputting the collected metrics associated with the workload and the corresponding auxiliary software component collected in step S02 to the prediction model to obtain predicted metrics of the corresponding auxiliary software component (S06). In FIG. 5, the inputted metrics associated with the workload are 2, 5, 4, 2, and 3 before the changed is applied. The inputted metrics associated with the first auxiliary software component 1 are 2, 3, 2, 1, and 2. The inputted metrics associated with the third auxiliary software component 3 are 1, 3, 2, 1, and 2. They were all collected before the changed is applied.

A last step of the prediction-based method is calculating a performance difference value by using the recorded metrics associated with the corresponding auxiliary software component and the predicted metrics of the corresponding auxiliary software component (S07). The performance difference value is used to describe the trend and approximate magnitude of the difference between predicted values and observed values. There are many methods to generate the performance difference value. In this embodiment, Mean Percentage Error (MPE) is used. MPE is the computed average of percentage errors by which prediction of a model differ from actual values of the quantity being predicted. The formula of MPE's is

$$MPE ( x , y ) = \frac{100}{k} \times {\sum }_{i = 1 … k} ( {y}_{i} - {x}_{i} ) / {x}_{i}$$

where yᵢ refers to all observed data, xᵢ is predicted value corresponding to yᵢ, and k is the number of different times for which the variable is estimated. In this embodiment, yᵢ are the numbers at item description No. 8 or No. 10, from T6 to T10. Therefore, k is 5 for 5 sets of number are recorded. xᵢ are numbers at item description No. 11 or No. 13, from T6 to T10. Calculating with relevant data above, the MPE for the recorded metrics associated with the first auxiliary software component 1 and the predicted metrics of the first auxiliary software component 1 is 50.00% while the MPE for the recorded metrics associated with the third auxiliary software component 3 and the predicted metrics of the third auxiliary software component 3 is −30.00%.

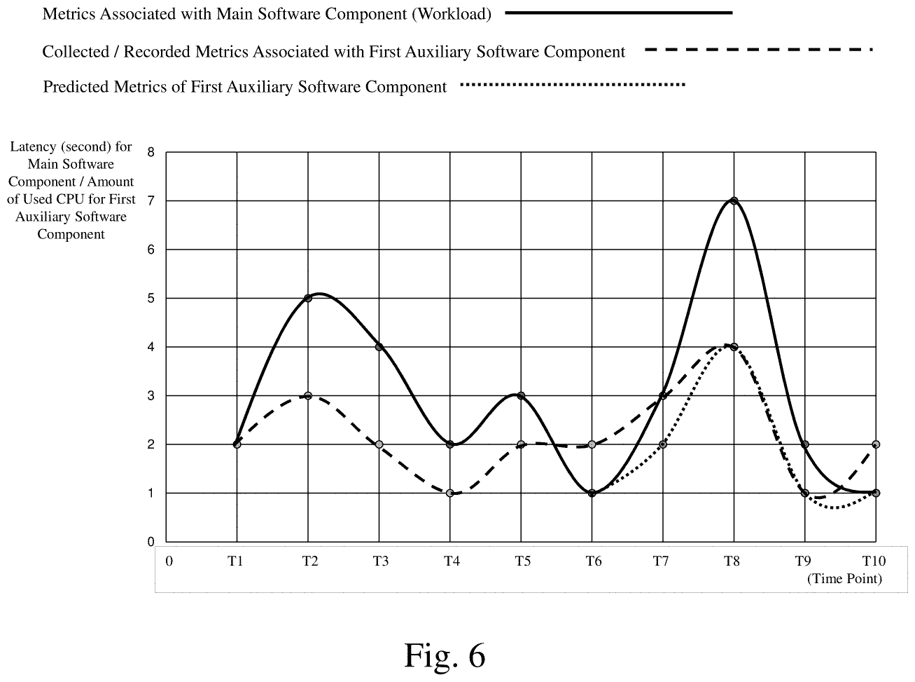

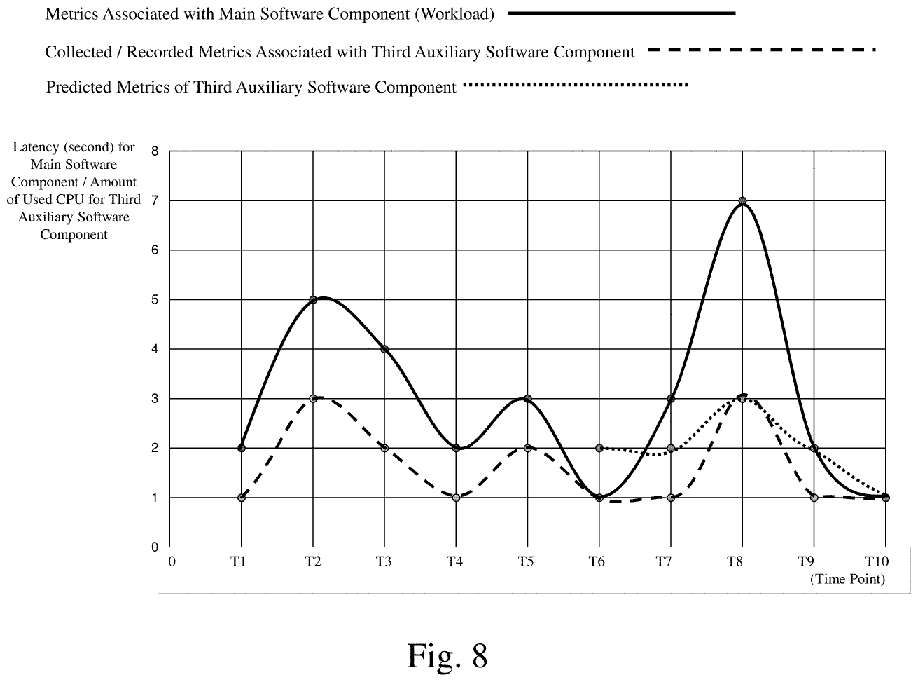

Please refer to FIG. 6. It is a graph showing metrics associated with workload, collected/recorded metrics associated with the first auxiliary software component 1, and predicted metrics of the first auxiliary software component 1 changing with time. Before T6, a trend of the workload is similar to that of the collected metrics associated with the first auxiliary software component 1. Crests and troughs occur at the same time point. A prediction (shown by dot line) is obtained according to the above steps. The recorded metrics associated with the first auxiliary software component 1 and the predicted metrics of the first auxiliary software component 1 are different and have different trends. Averagely, the change causes the predicted metrics of the first auxiliary software component 1 50.00% higher than they should be. Similarly, please see FIG. 8. It is a graph showing metrics associated with workload, collected/recorded metrics associated with the third auxiliary software component 3, and predicted metrics of the third auxiliary software component 3 changing with time. Before T6, a trend of the workload is similar to that of the collected metrics associated with the third auxiliary software component 3. A prediction (shown by dot line) is obtained according to the above steps, too. The recorded metrics associated with the third auxiliary software component 3 and the predicted metrics of the third auxiliary software component 3 are different and have different trends. Averagely, the change causes the predicted metrics of the third auxiliary software component 3 30.00% lower than they should be. Once the performance difference value is obtained, the amount of impacted metrics caused by the change may be foreseen. Necessary adjustments of the computing hardware environment can be made.

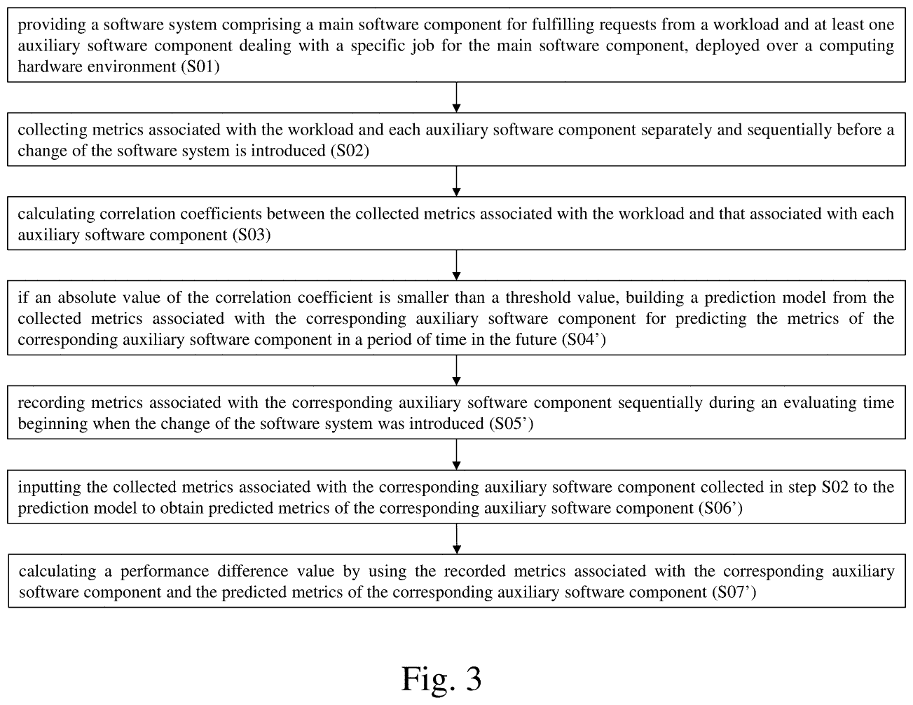

Under the condition that the absolute value of the correlation coefficient is smaller than the threshold value, the present invention has an alternative way to analyze change impact on software components. Please refer to FIG. 3. It is another flow chart of a prediction-based method for analyzing change impact on software components for the above condition.

If an absolute value of the correlation coefficient is smaller than a threshold value, an alternative fourth step is building a prediction model from the collected metrics associated with the corresponding auxiliary software component for predicting the metrics of the corresponding auxiliary software component in a period of time in the future (S04′). Here, the threshold value keeps the same as 0.7. The absolute value of the correlation coefficient smaller than 0.7 also indicates there is a week correlation or no correlation between the collected metrics associated with the workload and the collected metrics associated with the corresponding auxiliary software component. From FIG. 5, the correlation coefficient between the collected metrics associated with the workload and the collected metrics associated with the second auxiliary software component 2 meets the requirements. The prediction model is built by ARIMA. The prerequisite for building the prediction model is inputs must be the collected metrics associated with the second auxiliary software component 2 before T6.

Then, based on the result of the step S04′, an alternative fifth step of the prediction-based method is recording metrics associated with the corresponding auxiliary software component sequentially during an evaluating time beginning when the change of the software system was introduced (S05′). Here, the second auxiliary software component 2 is so-called corresponding software components in step S05′. Therefore, the metrics associated with the second auxiliary software component 2 are recorded by the metric collector B. The recorded metrics associated with the second auxiliary software component 2 from T6 to T10 are 3, 2, 3, 2, and 3.

An alternative sixth step of the prediction-based method is inputting the collected metrics associated with the corresponding auxiliary software component in step S02 to the prediction model to obtain predicted metrics of the corresponding auxiliary software component (S06′). In FIG. 5, the inputted metrics are 2, 2, 3, 3, and 4.

A last alternative step of the prediction-based method is calculating a performance difference value by using the recorded metrics associated with the corresponding auxiliary software component and the predicted metrics of the corresponding auxiliary software component (S07′). Step S07 is exactly the same as step SOT but different in the way the calculated data are generated. MPE is still used as the performance difference value. According to the formula, yᵢ are the numbers at item description No. 9, from T6 to T10. k is 5. xᵢ are numbers at item description No. 12 from T6 to T10. Calculating with relevant data above, the MPE for the recorded metrics associated with the second auxiliary software component 2 and the predicted metrics of the second auxiliary software component 2 is 90.00%.

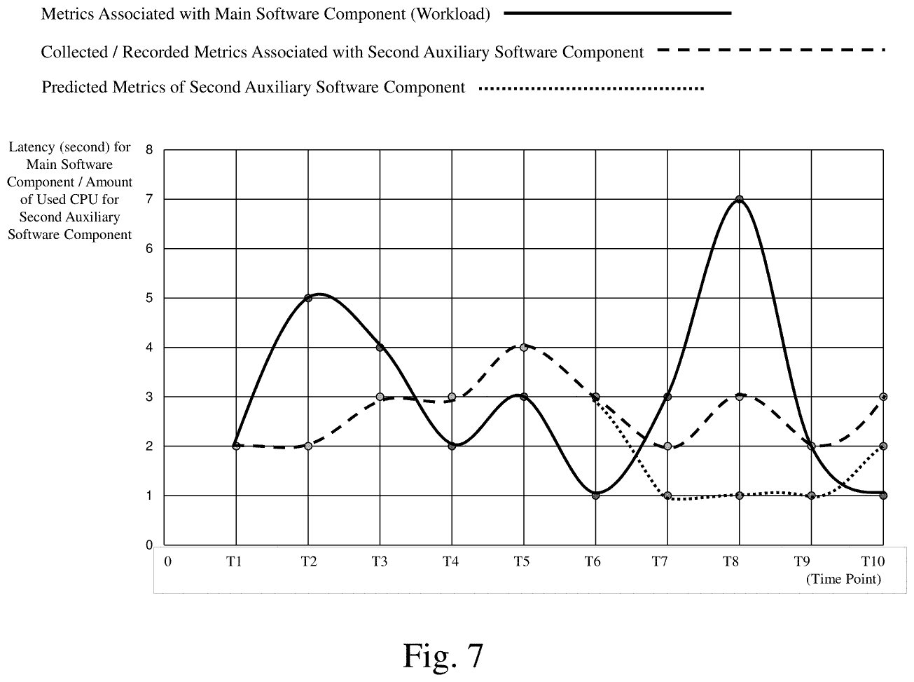

Please refer to FIG. 7. It is a graph showing metrics associated with workload, collected/recorded metrics associated with the second auxiliary software component 2, and predicted metrics of the second auxiliary software component 2 changing with time. Before T6, a trend of the workload is not similar to that of the collected metrics associated with the second auxiliary software component 2. A prediction (shown by dot line) is obtained according to the above alternative steps. The recorded metrics associated with the second auxiliary software component 2 and the predicted metrics of the second auxiliary software component 2 are different and have different trends. Averagely, the change causes the predicted metrics of the second auxiliary software component 2 90.00% higher than they should be.

In the embodiment, the time point comes one by one continuously. In practice, there can be an interrupt between T5 and T6. Namely, data for building a prediction model can be collected much earlier than the change is introduced. In addition, since workload pattern is most likely based on time of the day, or day of the week, it will be beneficial to build the prediction models in similar time of the day (or day of the week) for the software system for each analysis. The collected/recorded metrics may be obtained at other times.

The change impact analysis has below advantages. First, impacted software component by the change can be identified as well as its affected value. For DevOps team, they want to know, after rolling out a new software change of one or more software component, the performance of the software system is gain or loss. Engineering team can confirm if the result is expected or if anything out of ordinary. This is a feedback to the engineering team. Secondly, it is easy to evaluate if some system parameter should be adjusted for such change. For example, the configuration settings of a database/backend service may add a new cluster node, several CPU or memory modules to the computing hardware environment. Operation team can also analyze with quantified results that help them evaluate the change they made has or has not achieved their expectations. If the performance impact is too much, a possible action could be rolling back the change made.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A prediction-based method for analyzing change impact on software components, comprising the steps of:
a) providing a software system comprising a main software component for fulfilling requests from a workload and at least one auxiliary software component dealing with a specific job for the main software component, deployed over a computing hardware environment;
b) collecting metrics associated with the workload and each auxiliary software component separately and sequentially before a change of the software system is introduced;
c) calculating correlation coefficients between the collected metrics associated with the workload and that associated with each auxiliary software component;
d) if an absolute value of the correlation coefficient is greater than a threshold value, building a prediction model from the collected metrics associated with the workload and the collected metrics associated with the corresponding auxiliary software component for predicting the metrics of the corresponding auxiliary software component in a period of time in the future;
e) recording metrics associated with the corresponding auxiliary software component and the workload sequentially during an evaluating time beginning when the change of the software system was introduced;
f) inputting the collected metrics associated with the workload and the corresponding auxiliary software component collected in step b) to the prediction model to obtain predicted metrics of the corresponding auxiliary software component; and
g) calculating a performance difference value by using the recorded metrics associated with the corresponding auxiliary software component and the predicted metrics of the corresponding auxiliary software component.

2. The prediction-based method according to claim 1, wherein the change of the software system is an upgrade of the software system, an adjustment of application configuration parameters of the software system, installing a new auxiliary software component, or deleting a current auxiliary software component.

3. The prediction-based method according to claim 1, wherein the computing hardware environment is a workstation host or a server cluster.

4. The prediction-based method according to claim 1, wherein the metric is amount of used memory, amount of used CPU, I/O throughput, response time, request per second, or latency.

5. The prediction-based method according to claim 1, wherein the performance difference value is mean percentage error.

6. The prediction-based method according to claim 1, wherein the collected metrics for building the prediction model are of two categories.

7. The prediction-based method according to claim 1, wherein the prediction model is built by a timeseries forecasting algorithm.

8. The prediction-based method according to claim 7, wherein the timeseries forecasting algorithm is ARIMA (Auto Regressive Integrated Moving Average) or SARIMA (Seasonal Auto Regressive Integrated Moving Average).

9. A prediction-based method for analyzing change impact on software components, comprising the steps of:
a) providing a software system comprising a main software component for fulfilling requests from a workload and at least one auxiliary software component dealing with a specific job for the main software component, deployed over a computing hardware environment;
b) collecting metrics associated with the workload and each auxiliary software component separately and sequentially before a change of the software system is introduced;
c) calculating correlation coefficients between the collected metrics associated with the workload and that associated with each auxiliary software component;
d) if an absolute value of the correlation coefficient is smaller than a threshold value, building a prediction model from the collected metrics associated with the corresponding auxiliary software component for predicting the metrics of the corresponding auxiliary software component in a period of time in the future;
e) recording metrics associated with the corresponding auxiliary software component sequentially during an evaluating time beginning when the change of the software system was introduced;
f) inputting the collected metrics associated with the corresponding auxiliary software component collected in step b) to the prediction model to obtain predicted metrics of the corresponding auxiliary software component; and
g) calculating a performance difference value by using the recorded metrics associated with the corresponding auxiliary software component and the predicted metrics of the corresponding auxiliary software component.

10. The prediction-based method according to claim 9, wherein the change of the software system is an upgrade of the software system, an adjustment of application configuration parameters of the software system, installing a new auxiliary software component, or deleting a current auxiliary software component.

11. The prediction-based method according to claim 9, wherein the computing hardware environment is a workstation host or a server cluster.

12. The prediction-based method according to claim 9, wherein the metric is amount of used memory, amount of used CPU, I/O throughput, response time, request per second, or latency.

13. The prediction-based method according to claim 9, wherein the performance difference value is mean percentage error.

14. The prediction-based method according to claim 9, wherein the collected metrics for building the prediction model are of two categories.

15. The prediction-based method according to claim 9, wherein the prediction model is built by a timeseries forecasting algorithm.

16. The prediction-based method according to claim 15, wherein the timeseries forecasting algorithm is ARIMA (Auto Regressive Integrated Moving Average) or SARIMA (Seasonal Auto Regressive Integrated Moving Average).
